(19) United States
(12) Patent Application Publication
(10) Pub. No.: US 2019/0196996 A1
(43) Pub. Date: Jun. 27, 2019

(54) DYNAMICALLY DETERMINING MEMORY ACCESS BURST LENGTH

(71) Applicant: Advanced Micro Devices, Inc., Sunnyvale, CA (US)

(72) Inventors: Kedarnath Balakrishnan, Whitefield (IN); Ravindra N. Bhargava, Austin, TX (US); Guanhao Shen, Austin, TX (US); James Raymond Magro, Austin, TX (US); Kevin M. Brandl, Austin, TX (US)

(21) Appl. No.: 15/851,087

(22) Filed: Dec. 21, 2017

(51) Int. Cl. G06F 13/30; G06F 13/16; G06F 3/06

(52) U.S. Cl. CPC G06F 13/30; G06F 13/1642; G06F 3/061; G06F 3/0659; G06F 13/1668

(57) ABSTRACT

Systems, apparatuses, and methods for performing efficient memory accesses for a computing system are disclosed. When a memory controller in a computing system determines a threshold number of memory read requests have been sent to a memory device in a read mode of a data bus, the memory controller determines a threshold number of memory write requests to send to the memory device in an upcoming write mode is a number of outstanding memory write requests. Alternatively, the memory controller determines the threshold number of memory write requests to send to the memory device in an upcoming write mode is a maximum value of the number of outstanding memory write requests and a programmable value of the write burst length stored in a control register. Therefore, the write burst length is determined dynamically. Similarly, the read burst length is determined dynamically when the write mode ends.

### BACKGROUND

### Description of the Related Art

Computing systems are typically designed with one or more processors configured to process program instructions and use a memory device for storage of data. Typically, the processors are coupled to the memory device via a memory controller. When a processor generates a memory read request or memory write request, the request is conveyed from the processor to the memory controller where they are stored in one or more queues while they await further processing. The memory controller then schedules the received requests for processing by generating read and write transactions to the memory device(s).

In many systems, a data bus connecting the memory controller to the memory device is configured to communicate data in only one direction at a time. For example, when the memory controller sends data to be stored in the memory device, the data bus operates to communicate data from the memory controller to the memory device. Conversely, when the memory controller is receiving data from the memory device, the data bus operates to communicate data from the memory device to the memory controller. When a change is made between operating the bus in one direction to operating the bus in the other direction, the change in direction is generally referred to as a “bus turnaround.” While this bus turnaround occurs, no data can be transmitted in either direction. Consequently, the effective bandwidth of the bus during the bus turnaround period is zero. As such, these bus turnaround periods reduce the overall bandwidth of the bus, with more bus turnarounds resulting in a lower overall bandwidth for the bus. Because the memory controller schedules processing of the read and write requests, how the requests are scheduled has a direct impact on the overall effective bandwidth of the data bus.

In view of the above, efficient methods and systems for performing efficient memory accesses for a computing system are desired.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one embodiment of a computing system.

FIG. 2 is a block diagram of one embodiment of a memory controller.

FIG. 3 is a flow diagram of one embodiment of a method for performing efficient memory accesses for a computing system.

FIG. 4 is a flow diagram of another embodiment of a method for performing efficient memory accesses for a computing system.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Various systems, apparatuses, methods, and computer-readable mediums for performing efficient memory accesses for a computing system are disclosed. In one embodiment, a computing system includes one or more computing resources and external system memory, such as one of a variety of types of random access memory (e.g., DRAM or otherwise). Examples of the computing resources include a general-purpose central processing unit (CPU), a graphics processing unit (GPU), an accelerated processing unit (APU), and so forth. The computing resources generate memory requests. In various embodiments, a given computing resource includes a cache memory sub system.

When a computing resource generates a memory access request (generally referred to herein as a “memory request”), the memory request is conveyed to a memory device via a memory controller. The memory controller is coupled to the memory device via a data bus (or “memory” bus). In various embodiments the memory device is off-chip (i.e., is a distinct component from the processors and/or memory controller). In other embodiments, the memory is on-chip. If the computing system includes multiple memory devices, then the address spaces are distributed among the multiple memory devices by the operating system. The memory controller supports mapping between the request addresses of the computing resources and addresses pointing to storage locations in the memory device(s). In some embodiments, a memory controller is connected to a single memory device. In other embodiments, a memory controller is connected to multiple memory devices. In various embodiments, the memory controller includes one or more queues for storing memory requests. In an embodiment, the memory controller includes a read queue for storing memory read requests and a separate write queue for storing memory write requests. In other embodiments, the memory controller includes a unified queue for storing both memory read requests and memory write requests. In yet other embodiments, the memory controller includes one or more queues for storing received memory requests and a separate queue for storing scheduled memory requests selected from the one or more queues. Further, in various embodiments, the memory controller supports out-of-order issue of the memory requests to the memory device based on priorities, target addresses, or other considerations.

In various embodiments, the memory controller includes control and status registers and a control unit with control logic for storing thresholds and other data used for control decisions. The control logic in the memory controller determines which one of a read mode and a write mode is a current mode for the data bus and the memory device. In an embodiment, a threshold may be established (e.g., via a programmable register or otherwise) that indicates a number of memory requests to send from the memory controller to the memory device prior to a data bus turnaround. This threshold number of memory requests to send is referred to as the “burst length”. As noted above, in various embodiments the data bus can only communicate data in one direction at a time. In order to change from one direction to the other, a data bus turnaround must be performed during which no data can be transferred via the bus. In various embodiments, the data bus utilizes a bidirectional shared-bus structure. When a bus driver stops driving information in a given direction on the data bus, a delay occurs before another bus driver is able to drive information in the opposite direction.

In some embodiments, a count of remaining read requests to send is updated when memory read requests are sent from the memory controller to the memory device. The count is incremented or decremented depending on the initial value of the count, which may increment from zero to the threshold number of memory read requests, or read burst length, or alternatively decrement from the read burst length to zero. In various embodiments, a write count is updated in a similar manner based on the initial value of count when memory write requests are sent from the memory controller to the memory device. For sending write requests to the memory device, a write burst length is used.

As used herein, “memory read requests” are memory requests configured to read data from the memory device and may also be referred to as read requests. Similarly, “memory write requests” are memory requests configured to write data to the memory device and may also be referred to as write requests. For read requests, a read response sent from the memory device to the memory controller includes the data that was requested in the read request. Similarly, the read response sent from the memory controller to the computing resource which generated the read request includes the data requested in the read request. For write requests, the write response sent from the memory controller to the computing resource which generated the write request includes an acknowledgment that the write operation completed. In various embodiments, no acknowledgment is sent from the memory device to the memory controller. Therefore, in an embodiment, the write request is considered completed when the write data following the write request is sent from the memory controller to the memory device.

When the control logic determines that a threshold number of memory requests (the burst length) has been sent from the memory controller to the memory device during a current mode, the control logic indicates it is time for a data bus turnaround and changes the current mode to another mode of the read mode and the write mode. For example, when the current mode is a read mode and the control logic determines the threshold number of memory read requests (the read burst length) have been sent from the memory controller to the memory device, the control logic indicates it is time for a data bus turnaround and changes the current mode of the memory controller from the read mode to the write mode. While this data bus turnaround occurs, no data can be transferred via the data bus.

In various embodiments, one or more of the read burst length and the write burst length are dynamically determined rather than statically determined. In one embodiment, when the control logic in the memory controller determines it is time to switch from a read mode to a write mode, the control logic determines a threshold number of memory write requests to send to the memory device in an upcoming write mode is equal to a number of outstanding memory write requests (e.g., the number of received write requests in a pending queue). Therefore, as the number of pending write requests may vary during processing, the write burst length may likewise vary during processing and is determined dynamically during each mode switch of the data bus and memory device from a read mode to a write mode.

In another embodiment, when the control logic in the memory controller determines it is time to switch from a read mode to a write mode, the control logic determines and sets the number of memory write requests to send to the memory device in an upcoming write mode equal to the greater of the number of outstanding memory write requests and a threshold value of the write burst length (e.g., a programmable or predetermined value). Therefore, again, the write burst length is determined dynamically during a mode switch of the data bus and memory device from a read mode to a write mode.

In yet other embodiments, when the control logic in the memory controller determines it is time for any switch of the current mode (e.g., read-to-write, write-to-read), the control logic determines a threshold number of memory requests to send to the memory device in an upcoming write mode or read mode is the greater of the number of outstanding memory requests of a type associated with the upcoming mode and a programmable value of the burst length stored in a control register associated with the upcoming mode. Therefore, each of the read burst length and the write burst length is determined dynamically during each corresponding mode switch of the data bus and memory device.

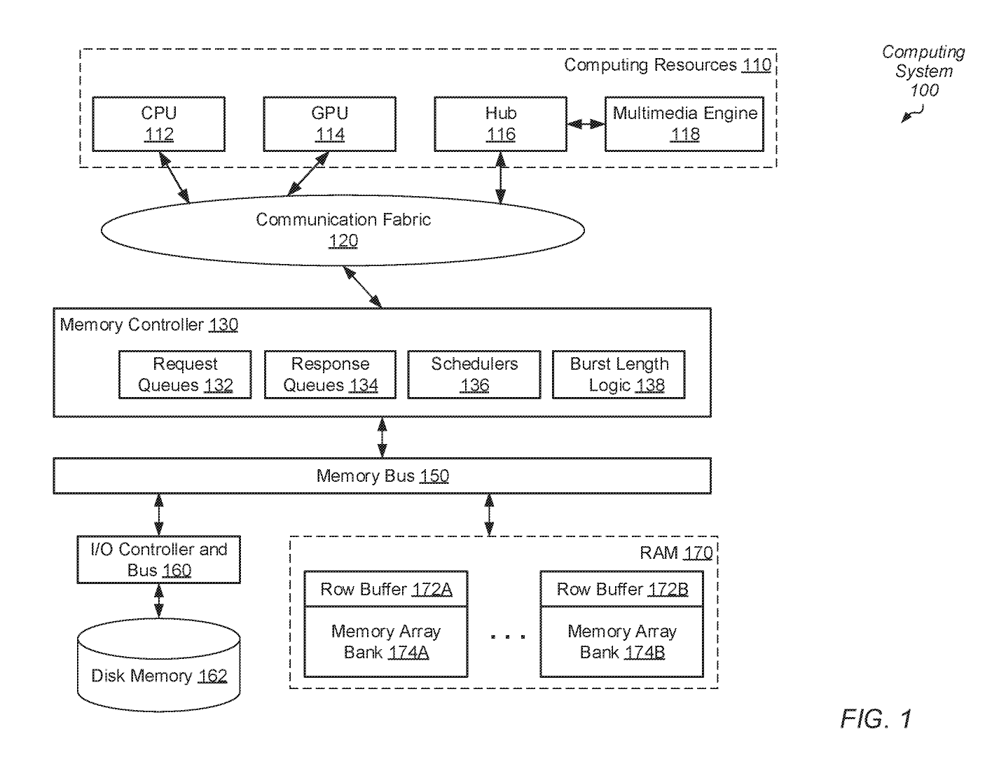

Referring to FIG. 1, a generalized block diagram of one embodiment of a computing system 100 is shown. As shown, computing system 100 includes communication fabric 120 between each of memory controller 130 and computing resources 110. In the illustrated embodiment, the computing resources include central processing unit (CPU) 112, graphics processing unit (GPU) 114 and Hub 116. Hub 116 is used for communicating with Multimedia Engine 118. Although a single memory controller 130 is shown, in other embodiments, another number of memory controllers are used in computing system 100. Memory controller 130 receives memory requests from computing resources 110 via the communication fabric 120 and sends the memory requests to one or more of disk memory 162 and system memory, which is implemented a random access memory (RAM) 170. Memory controller 130 also receives responses from RAM 170 and disk memory 162 and sends the responses to a corresponding source of the request in computing resources 110.

In some embodiments, the components of computing system 100 are individual dies on an integrated circuit (IC), such as a system-on-a-chip (SOC). In other embodiments, the components are individual dies in a system-in-package (SiP) or a multi-chip module (MCM). In one embodiment, computing system 100 is a stand-alone system within a mobile computer, a smart phone, a smartwatch, or a tablet; a desktop; a server; or other. The CPU 112, GPU 114 and Multimedia Engine 118 are examples of computing resources capable of generating memory requests. Although not shown, in other embodiments, other types of computing resources are included in computing resources 110.

Each of the one or more processor cores in CPU 112 includes circuitry for executing instructions according to a given selected instruction set architecture (ISA). In various embodiments, each of the processor cores in CPU 112 includes a superscalar, multi-threaded microarchitecture used for processing instructions of the given ISA. In an embodiment, GPU 114 includes a high parallel data microarchitecture with a significant number of parallel execution lanes. In one embodiment, the microarchitecture uses single-instruction-multiple-data (SIMD) pipeline for the parallel execution lanes. Multimedia Engine 118 includes processors for processing audio data and visual data for multimedia applications.

In one example, an accelerated processing unit (APU), a display controller, an audio processor, and so forth, are additional candidates to be included in processing units 110. An example of an APU is a CPU integrated on a same die with a GPU, a FPGA, or other processing unit, thus improving data transfer rates between these units while reducing power consumption. In other embodiments, the APU includes video processing and other application-specific accelerators.

In various embodiments, communication fabric 120 transfers traffic back and forth between processing units 110 and memory controller 130 and includes interfaces for supporting respective communication protocols. In some embodiments, communication fabric 120 includes at least queues for storing requests and responses, selection logic for arbitrating between received requests before sending requests across an internal network, logic for building and decoding packets, and logic for selecting routes for the packets.

In some embodiments, the address space of the computing system 100 is divided among at least CPU 112, GPU 114 and Hub 116 and one or more other components such as input/output peripheral devices (not shown) and other types of computing resources. Memory maps are maintained for determining which addresses are mapped to which component, and hence to which one of CPU 112, GPU 114 and Hub 116 a memory request for a particular address should be routed.

As software applications access more and more data, the memory subsystem is utilized more heavily. One or more of the computing resources within processing units 110 include cache memory subsystems to reduce memory latencies for a respective processor core. As used herein, the term “access” refers to performing a memory read request or a memory write request operation that results in a cache hit if the requested data of a corresponding request address resides in the cache. Alternatively, the memory request results in a cache miss if the requested data does not reside in the cache. If a cache miss occurs, then a memory request is generated and transmitted to the memory controller 130. The memory controller 130 translates an address corresponding to the requested block and sends the memory request to RAM 170 through the memory bus 150.

In an embodiment, RAM 170 includes a multi-channel memory architecture. This type of architecture increases the transfer speed of data to the memory controller 130 by adding more channels of communication between them. In an embodiment, the multi-channel architecture utilizes multiple memory modules and a motherboard and/or a card capable of supporting multiple channels. In some embodiments, RAM 170 is a type of dynamic random-access memory that stores each bit of data in a separate capacitor within an integrated circuit. In another embodiment, RAM 170 utilizes three-dimensional integrated circuits (3D ICs) to provide system memory.

As shown, RAM 170 includes multiple memory array banks 174A-174B. Each one of the banks 174A-174B include a respective one of the row buffers 172A-172B. Each one of the row buffers 172A-172B stores data in an accessed row of the multiple rows within the memory array banks 174A-174B. The accessed row is identified by a DRAM address in the received memory request. Control logic within RAM 170 performs complex transactions such as activation and precharge of data and control lines within RAM 170 once to access an identified row and once to put back the modified contents stored in the row buffer to the identified row. In an embodiment, the complex transactions are performed based on commands sent from the memory controller 130. In various embodiments, RAM 170 includes one or more memory channels, one or more memory modules or devices per channel, one or more ranks per memory module, one or more banks per rank, and one or more rows per bank. Typically, each row stores a page of data. The size of the page is chosen based on design considerations. The page can be one kilobyte (1 KB), four kilobytes (4 KB), or any size based on design choices.

Accesses of RAM 170 generally include an activation stage, precharge stage, switches to different banks between adjacent accesses, switches to different ranks between adjacent accesses, and so forth. In addition, as already noted, no data can be transmitted via the data bus during a data bus turnaround. For example, when write requests corresponding to a write mode have been serviced and the end of the write mode is reached the read mode begins after the data bus turnaround completes. Similarly, when read requests corresponding to the read mode have been serviced and the end of the read mode is reached, another write mode begins after the data bus turnaround completes.

As shown, memory controller 130 includes request queues 132 for queuing memory requests received from processing units 110 via communication fabric 120. Memory controller 130 also has a response queue(s) 134 for storing responses received from RAM 170. In an embodiment, request queues 132 include one or more queues for storing memory requests. In another embodiment, request queues 132 include a read queue for storing memory read requests and a separate write queue for storing memory write requests. In other embodiments, request queues 132 include a unified queue for storing both memory read requests and memory write requests. Still further, request queues 132 include one or more queues for storing received memory requests and a separate queue for storing scheduled memory requests selected from the one or more queues.

Schedulers 136 include logic (e.g., circuitry) for selecting memory requests stored in request queues 132 for issue to RAM 170. In various embodiments, schedulers 136 in memory controller 130 schedule the issue of the stored memory requests based on a quality-of-service (QoS) or other priority information, age, a process or thread identifier (ID), and a relationship with other stored requests such as targeting a same memory channel, targeting a same rank, targeting a same bank and/or targeting a same page. In various embodiments, schedulers 136 schedule outstanding memory requests based at least upon reducing a number of page conflicts and a number of page misses.

In various embodiments, memory bus 150 supports sending data traffic on a data bus in a single direction while in one mode of a read mode and a write mode, and then sends data traffic in the opposite direction while in the other mode. In an embodiment, memory bus 150 utilizes at least a command bus and a data bus, and memory bus 150 supports a read mode for sending data traffic on the data bus from RAM 170 to memory controller 130. Additionally, memory bus 150 supports a write mode for sending data traffic on the data bus from memory controller 130 to RAM 170.

Control logic in memory controller 130 determines which one of a read mode and a write mode is a current mode for the data bus in memory bus 150. Each mode has a threshold number of memory requests to send from the memory controller to the memory device prior to a data bus turnaround. This threshold number of memory requests to send is the burst length. When the control logic determines the threshold number of memory requests have been sent in the current mode, the control logic indicates it is time for a data bus turnaround and changes the current mode to another mode of the read mode and the write mode.

In one embodiment, when control logic in memory controller 130 determines it is time to switch from a read mode to a write mode, burst length logic 138 dynamically determines a threshold number of memory write requests to send to RAM 170 in an upcoming write mode. In various embodiments, this dynamically determined number is set equal to a number of outstanding memory write requests stored in request queues 132. Therefore, the write burst length is determined dynamically by burst length logic 138 during each mode switch of the data bus and memory device from a read mode to a write mode. In various embodiments, when control logic in memory controller 130 determines it is time to switch from a read mode to a write mode, burst length logic 138 dynamically determines a threshold number of memory write requests to send to RAM 170 is equal to the greater of a number of memory write requests that are outstanding (e.g., are currently stored and awaiting servicing in the memory controller) and a programmable (or predetermined) value for a write burst length stored in a control register.

In yet other embodiments, when control logic in memory controller 130 determines it is time for any switch of the current mode (e.g., read-to-write, write-to-read), burst length logic 138 determines a threshold number of memory requests to send to RAM 170 in an upcoming write mode or read mode is the greater of a number of outstanding memory requests of a type associated with the upcoming mode and a programmable (or predetermined) value of the burst length stored in a control register associated with the upcoming mode.

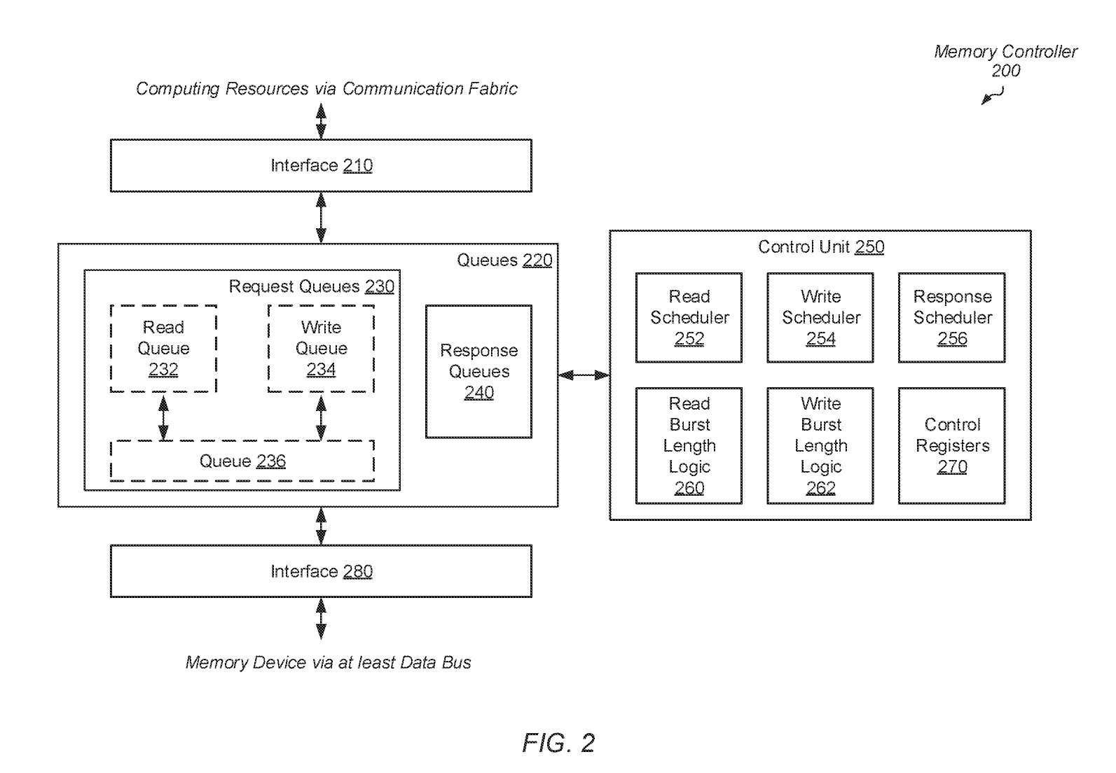

Referring to FIG. 2, a generalized block diagram of one embodiment of a memory controller 200 is shown. In the illustrated embodiment, memory controller 200 includes an interface 210 to computing resources via a communication fabric, queues 220 for storing received memory requests and received responses, control unit 250 and an interface 280 to a memory device via at least a data bus of a memory bus. Each of interfaces 210 and 280 supports respective communication protocols.

In an embodiment, queues 220 includes a read queue 232 for storing received read requests and a separate write queue 234 for storing received write requests. In other embodiments, queues 220 includes a unified queue for storing both memory read requests and memory write requests. In one embodiment, queues 220 includes queue 236 for storing scheduled memory requests selected from read queue 232, write queue 234 or a unified queue if one is used.

In some embodiments, read scheduler 252 includes arbitration logic for selecting read requests from the read queue 220 out-of-order. Read scheduler 252 schedules the issue of the stored requests within the read queue 220 to the memory device based on any of a variety of conditions, such as a quality-of-service (QoS) or other priority information, age, a process or thread identifier (ID), and a relationship with other stored requests such as targeting a same memory channel, targeting a same rank, targeting a same bank and/or targeting a same page. Write scheduler 254 includes similar selection logic for the write queue 234. In an embodiment, response scheduler 256 includes similar logic for issuing, based on priorities, responses to the computing resources, which were received from the memory device.

In some embodiments, control registers 270 store an indication of a current mode for a data bus coupled to a memory device (not shown). For example, in various embodiments, the memory data bus and memory device are configured to support a read mode and a write mode. As discussed above, data transfers via the data bus can only move in a single direction at any given time. When switching from one mode to the other, no data can be transferred via the data bus. In various embodiments, control registers 270 store a number of read requests (read burst length) to send during the read mode. In some embodiments, the control registers 270 also store a write bust length. In some embodiments, the burst length is the same for each of the read mode and the write mode. In other embodiments, two different burst lengths are used for the read mode and the write mode.

In one embodiment, when control logic in control unit 250 determines it is time to switch from a read mode to a write mode, write burst length logic 262 determines the number of memory write requests to send to the memory device in an upcoming write mode is equal to a number of outstanding memory write requests stored in queues 220. Therefore, the write burst length is determined dynamically during each mode switch of the data bus and memory device from a read mode to a write mode. In another embodiment, when the control logic in the memory controller determines it is time to switch from a read mode to a write mode, write burst length logic 262 determines the threshold number of memory write requests to send to the memory device in an upcoming write mode is equal to the greater of a number of outstanding memory write requests and a programmable (or predetermined) value of the write burst length.

In yet other embodiments, when the control logic in the memory controller determines it is time for any switch from the current mode (e.g., read-to-write, write-to-read), one of read burst length logic 260 and write burst length logic 262 determines a threshold number of memory requests to send to the memory device in an upcoming read mode or write mode is the greater of a number of outstanding memory requests of a type associated with the upcoming mode and a programmable (or predetermined) value of the burst length. In various embodiments, the above described programmable or predetermined values may be stored in control registers 270. In this manner, each of the read burst length and the write burst length is determined dynamically during system operation.

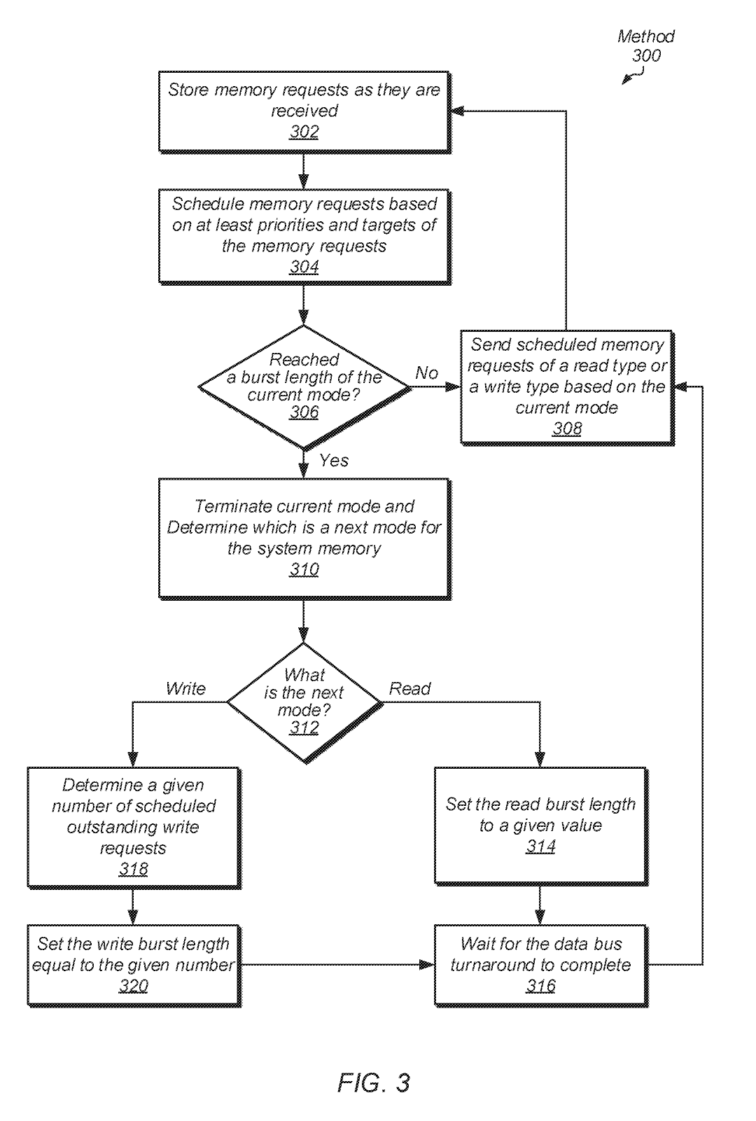

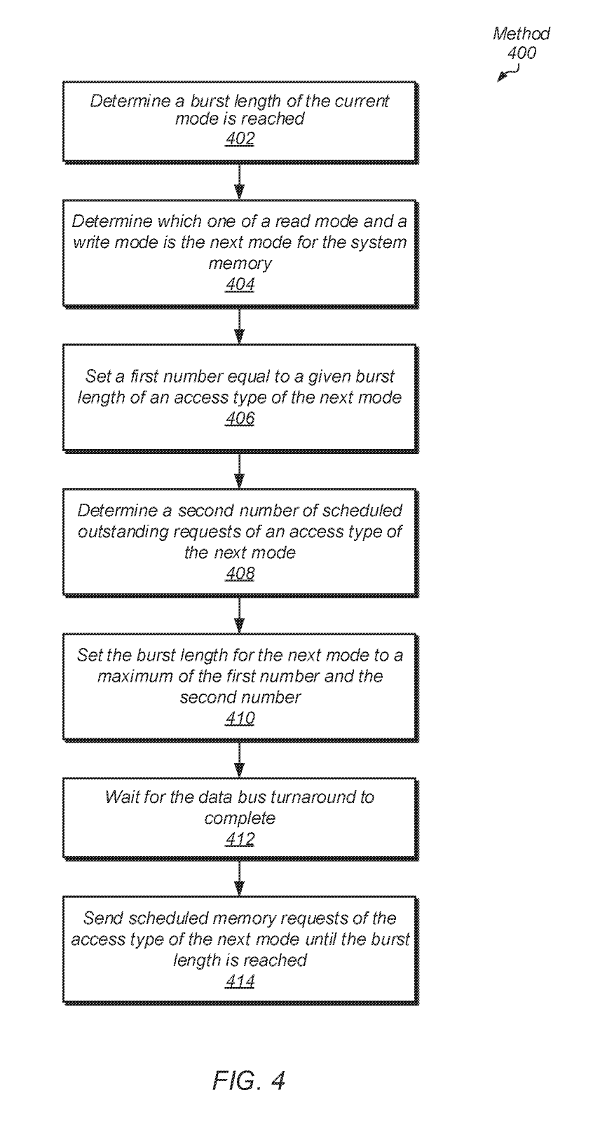

Referring now to FIG. 3, one embodiment of a method 300 for performing efficient memory accesses for a computing system is shown. For purposes of discussion, the steps in this embodiment (as well as in FIG. 4) are shown in sequential order. However, it is noted that in various embodiments of the described methods, one or more of the elements described are performed concurrently, in a different order than shown, or are omitted entirely. Other additional elements are also performed as desired. Any of the various systems or apparatuses described herein are configured to implement method 300.

One or more computing resources execute computer programs, or software applications. Examples of a computing resource are given earlier. The computing resource determines a given memory request misses within a cache memory subsystem within the computing resource. The computing resource sends the memory request to system memory such as DRAM via a memory controller. The memory controller stores memory requests in one or more queues (block 302).

The memory requests are scheduled based on at least priorities and targets of the memory requests (block 304). As described earlier, in various embodiments, memory requests are scheduled for issue based on one or more of a quality-of-service (QoS) or other priority information, age, a process or thread identifier (ID), and a relationship with other stored requests such as targeting a same memory channel, targeting a same rank, targeting a same bank and/or targeting a same page, or otherwise. If a burst length of the current mode has not been reached (“no” branch of the conditional block 306), then additional memory requests according to the current mode are sent to the system memory (block 308). However, if the burst length of the current mode has been reached (“yes” branch of the conditional block 306), then the current mode is terminated and which one of a read mode and a write mode is the next mode for the system memory is determined (block 310).

If the next mode is a read mode (“read” branch of the conditional block 312), then the read burst length is set to a given value (block 314), a data bus turnaround (block 316) is performed, and the read requests are serviced. In various embodiments, the given value is a predetermined value. In one embodiment, a programmable control register is read to determine the read burst length. Therefore, in some embodiments, the read burst length is determined statically in contrast to the write burst length being determined dynamically. However, in other embodiments, each of the read burst length and the write burst length is determined dynamically as described above and in FIG. 4. If the next mode is a write mode (“write” branch of the conditional block 312), then a number of write requests to be serviced is determined (block 318). In one embodiment, a “snapshot” of the current number of write requests in a queue (or other storage device) that have been received and are pending is taken. At any given time, this number will vary during operation of the system. The determined number of pending writes is then used to set a burst length for a write burst (block 320) and after the bus turnaround is completed (block 316), the write burst is performed (block 308). In various embodiments, the burst length is fixed at the number determined by the above mentioned snapshot—even if other write transactions are received before the write burst is completed. In other embodiments, one or more additional write transactions may be added to the write burst if such additional writes are received before completion of the write burst.

Referring to FIG. 4, another embodiment of a method 400 for performing efficient memory accesses for a computing system is shown. As shown in block 402, a burst length for the current mode is reached. Which one of a read mode and a write mode is the next mode for the system memory is determined (block 404). In some embodiments, the next mode is implicitly determined to be the opposite of the current mode. In an embodiment, a first number is set to a given burst length of an access type of the next mode (block 406). In various embodiments, the given value is a predetermined value. In one embodiment, a programmable register associated with the next mode is read to determine the first number (block 406). In addition, a second number of scheduled outstanding requests of an access type of the next mode is also determined (block 408). In one embodiment, a “snapshot” of the current number of pending write transactions in a queue is taken. At any given time, this number will vary during operation of the system. In this manner, the second number is determined dynamically. In some embodiments, a weight is associated with each write transaction stored in the queue. In an embodiment, the weight is set based on one or more of a quality-of-service (QoS) or other priority information, age, a process or thread identifier (ID), a determination of whether the write transaction can be grouped with other write transactions to reduce page conflicts and page misses, and so forth. Therefore, the second number is a weighted sum of the current number of write transactions that have been received and are pending. In an embodiment, the first number is adjusted based on the weights. For example, the programmable value stored in the configuration register associated with the next mode is selected based on knowledge of the ranges of the weights. Accordingly, the first number suggesting a given burst length of an access type of the next mode accounts for the use of the weights similar to the second number. In various embodiments, the burst length for the next mode is set to the greater of the first number and the second number (block 410). After the data bus turnaround is complete (block 412), the scheduled memory requests of the access type of the next mode are then sent until the burst length is reached (block 414).

In various embodiments, program instructions of a software application are used to implement the methods and/or mechanisms previously described. The program instructions describe the behavior of hardware in a high-level programming language, such as C. Alternatively, a hardware design language (HDL) is used, such as Verilog. The program instructions are stored on a non-transitory computer readable storage medium. Numerous types of storage media are available. The storage medium is accessible by a computing system during use to provide the program instructions and accompanying data to the computing system for program execution. The computing system includes at least one or more memories and one or more processors configured to execute program instructions.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A memory controller comprising:
a first interface for receiving memory access requests;
a second interface for sending memory access requests to a memory device;
one or more queues configured to store memory access requests; and
control logic;
wherein in response to determining an end of a read mode during which read requests are sent via the second interface, the control logic is configured to:
terminate the read mode and begin a write mode during which write requests are sent via the second interface;
dynamically determine a number of write requests to send as part of a write burst, wherein dynamically determining said number comprises determining how many write requests are currently pending;
send said number of write requests via the second interface; and
terminate the write mode and begin the read mode, in response to determining said number of write requests have been sent.

2. The memory controller as recited in claim 1, wherein dynamically determining the number of write requests comprises setting the number of write requests to send as part of the write burst equal to a greater of the number of write requests currently pending and a threshold number.

3. The memory controller as recited in claim 2, wherein the control logic is configured to send one or more write transactions as part of the write burst that arrived after the number of write requests to send was determined.

4. The memory controller as recited in claim 1, wherein to determine how many write requests are currently pending, the control logic is configured to determine how many write requests are currently stored in a queue of the one or more queues.

5. The memory controller as recited in claim 1, wherein the threshold number is a programmable value stored in a register.

6. The memory controller as recited in claim 1, wherein the control logic is further configured to schedule outstanding memory access requests based on at least one of reducing a number of page conflicts and reducing a number of page misses in memory access requests sent to the memory device.

7. The memory controller as recited in claim 1, wherein the second interface is connected to a plurality of memory devices, and wherein the control logic is further configured to schedule outstanding memory access requests based at least in part on reducing a number of switches between ranks of the plurality of memory devices.

8. A method, comprising:
receiving from one or more computing resources, memory access requests for data stored in a memory device;
storing, by a memory controller, the memory access requests in one or more queues;
in response to determining an end of a read mode during which read requests are sent to the memory device:
terminating, by the memory controller, the read mode and beginning a write mode during which write requests are sent to the memory device;
dynamically determining, by the memory controller, a number of write requests to send as part of a write burst, wherein dynamically determining said number comprises determining how many write requests are currently pending;
sending, by the memory controller, said number of write requests to the memory device; and
terminating, by the memory controller, the write mode and begin the read mode, in response to determining said number of write requests have been sent.

9. The method as recited in claim 8, wherein dynamically determining the number of write requests comprises setting the number of write requests to send as part of the write burst equal to a greater of the number of write requests currently pending and a threshold number.

10. The method as recited in claim 9, further comprising sending one or more write transactions as part of the write burst that arrived after the number of write requests to send was determined.

11. The method as recited in claim 8, wherein determining how many write requests are currently pending comprises determining how many write requests are currently stored in a queue of the one or more queues.

12. The method as recited in claim 8, wherein the threshold number is a programmable value stored in a register.

13. The method as recited in claim 8, wherein the method further comprises scheduling outstanding memory access requests based on at least one of reducing a number of page conflicts and a number of page misses in memory access requests sent to the memory device.

14. The method as recited in claim 8, further comprising:
sending memory access requests to a plurality of memory devices; and
scheduling outstanding memory access requests based at least in part on reducing a number of switches between ranks of the plurality of memory devices.

15. A computing system comprising:
a memory device configured to store data;
one or more computing resources, each configured to generate memory access requests for the data; and
a memory controller coupled to the memory device, wherein the memory controller is configured to:
store the memory access requests in one or more queues;
in response to determining an end of a read mode during which read requests are sent to the memory device, the memory controller is configured to:
terminate the read mode and begin a write mode during which write requests are sent via the second interface;
dynamically determine a number of write requests to send as part of a write burst, wherein dynamically determining said number comprises determining how many write requests are currently pending;
send said number of write requests to the memory device; and
terminate the write mode and begin the read mode, in response to determining said number of write requests have been sent.

16. The computing system as recited in claim 15, wherein dynamically determining the number of write requests comprises setting the number of write requests to send as part of the write burst equal to a greater of the number of write requests currently pending and a threshold number.

17. The computing system as recited in claim 16, wherein the memory controller is configured to send one or more write transactions as part of the write burst that arrived after the number of write requests to send was determined.

18. The computing system as recited in claim 15, wherein to determine how many write requests are currently pending, the memory controller is configured to determine how many write requests are currently stored in a queue of the one or more queues.

19. The computing system as recited in claim 15, wherein the threshold number is a programmable value stored in a register.

20. The computing system as recited in claim 15, wherein the memory controller is further configured to schedule outstanding memory access requests based on at least one of reducing a number of page conflicts and reducing a number of page misses in memory access requests sent to the memory device.
